(19) United States
(12) Patent Application Publication
(10) Pub. No.: US 2014/0137964 A1
(43) Pub. Date: May 22, 2014

(54) FUEL TANK SYSTEM

(71) Applicants: Shuichi Aso, Toyota-shi (JP); Masaki Akagi, Toyota-shi (JP); Yuusaku Nishimura, Toyota-shi (JP)

(72) Inventors: Shuichi Aso, Toyota-shi (JP); Masaki Akagi, Toyota-shi (JP); Yuusaku Nishimura, Toyota-shi (JP)

(73) Assignee: TOYOTA JIDOSHA KABUSHIKI KAISHA, Toyota-shi, Aichi (JP)

(21) Appl. No.: 14/232,344

(22) PCT Filed: Aug. 3, 2011
(86) PCT No.: PCT/JP2011/067794

§ 371 Date: Jan. 13, 2014

(51) Int. Cl. B60K 15/035

(52) U.S. Cl. CPC B60K 15/03519
USPC 137/587

(57) ABSTRACT

A fuel tank system in which a solenoid valve on piping that communicates between a fuel tank and a canister may be reduced in size. A valve member (a diaphragm valve) is disposed in vent piping that communicates between the fuel tank and the canister. A second bypass channel is provided between a back pressure chamber of the diaphragm valve and the canister side of the vent piping. The solenoid valve is disposed in the second bypass channel.

### TECHNICAL FIELD

The present invention relates to a fuel tank system.

### BACKGROUND ART

Japanese Patent Application Laid-Open (JP-A) No. 2005-104394 (Patent Document 1) recites an evaporated fuel discharge inhibiting device that is provided with an electromagnetic sealing valve on an evaporation line that reaches from a fuel tank to a canister. In the configuration recited in the Document, a sealed fuel tank system may be constituted by completely closing the evaporation line with the sealing valve.

However, in the fuel tank system with the configuration described above, when a valve body of the sealing valve moves to a valve-open position, the tank internal pressure in the fuel tank (a positive pressure) acts on a rear face of the valve (which is the face at the front side in the direction of movement). Therefore, a driving force required for valve opening is large, which leads to an increase in size of the sealing valve (a solenoid valve).

### DISCLOSURE OF INVENTION

### Technical Problem

In consideration of the situation described above, an object of the present invention is to provide a fuel tank system in which a solenoid valve on piping that communicates between a fuel tank and a canister may be reduced in size.

### Solution to Problem

A first aspect of the present invention includes a fuel tank capable of accommodating fuel therein; a canister that adsorbs and desorbs evaporated fuel, produced in the fuel tank, with an adsorbent; an atmospheric opening pipe for opening an interior of the canister to the atmosphere; vent piping that provides fluid communication between the fuel tank and the canister such that evaporated fuel in the fuel tank can flow to the canister; a valve member that partitions a main chamber from a back pressure chamber that is provided at an opposite side of a main body of the valve member from the main chamber, the main chamber and the back pressure chamber sandwiching the valve member main body, the main chamber being provided at the vent piping such that a tank internal pressure of the fuel tank acts at the main chamber, and the valve member opening and enabling fluid communication through the vent piping when a pressure in the main chamber is higher than a pressure in the back pressure chamber and the valve member main body moves; a first bypass channel that provides fluid communication between the vent piping from the fuel tank to the main chamber and the back pressure chamber; a second bypass channel that provides fluid communication between the vent piping from the main chamber to the canister and the back pressure chamber; and a solenoid valve that is provided at the second bypass channel and is controlled so as to open and close the second bypass channel.

In this fuel tank system, fluid communication between the fuel tank and the canister is enabled by the vent piping. At the vent piping, a bypass path that extends from the first bypass channel through the back pressure chamber to the second bypass channel is constituted. When the vent piping is closed off by the valve member to disable fluid communication and the solenoid valve provided at the second bypass channel is closed, evaporated fuel in the fuel tank may be sealed so as not to migrate to the canister.

When evaporated fuel in the fuel tank is to be sent to the canister, the solenoid valve opens and the second bypass channel is opened. Thus, the back pressure chamber is opened to the atmosphere. Meanwhile, because the internal pressure of the tank (a positive pressure) acts in the main chamber, the pressure in the main chamber is higher than the pressure in the back pressure chamber. Therefore, a force required for operation of the valve member in order to open the vent piping may be smaller than in a structure in which a back pressure chamber does not open to the atmosphere. Thus, it is sufficient for the solenoid valve to be of a size capable of opening and closing the second bypass channel. Therefore, the size of the solenoid valve may be made smaller than the size of the valve member.

In a second aspect of the present invention, in the first aspect, a pressure difference preserver for preserving a pressure difference between the main chamber and the back pressure chamber is provided.

Thus, in the state in which the solenoid valve is open and the back pressure chamber is opened to the atmosphere, the pressure difference between the main chamber and the back pressure chamber is regulated by the pressure difference preserver. That is, a state in which the pressure in the back pressure chamber is lower than the pressure in the main chamber may be more assuredly preserved.

It is sufficient that the preservation of the pressure difference by the pressure difference preserver be capable of preserving the pressure difference at a predetermined level over a longer duration than in a structure that does not include the pressure difference preserver.

In a third aspect of the present invention, in the second aspect, the pressure difference preserver is a reduced diameter portion at which a cross-sectional area of a flow path in the first bypass channel is locally reduced.

By the reduced diameter portion being provided in the first bypass channel, the pressure difference preserver may be constituted with a simple structure.

In a fourth aspect of the present invention, in any one of the first to third aspects, the solenoid valve includes a solenoid valve main body, a direction of force of positive pressure from the back pressure chamber matching a direction of movement of the solenoid valve main body when opening the second bypass channel.

When the solenoid valve main body of the solenoid valve moves in the direction of opening the second bypass channel and the valve opens, a positive pressure acts in the same direction (the valve-opening direction) from the back pressure chamber. Therefore, the force required for the operation of opening the solenoid valve is smaller than in a constitution in which a positive pressure does not act on the solenoid valve main body in the valve-opening direction from the back pressure chamber.

In a fifth aspect of the present invention, in any one of the first to fourth aspects, a fueling state sensor that detects a fueling state of the fuel tank; and a control device that controls the solenoid valve so as to close the second bypass channel in a state in which the fueling state of the fuel tank is not detected by the fueling state sensor, and so as to open the second bypass channel when the fueling state of the fuel tank is detected are provided.

In the state in which the state of fuelling of the fuel tank is not detected by the fuelling state sensor, the control device controls the solenoid valve and closes off the second bypass channel. The tank internal pressure of the fuel tank acts in the main chamber via the vent piping, and the tank internal pressure of the fuel tank also acts in the back pressure chamber via the vent piping and the first bypass channel. Therefore, the valve member does not unintendedly open up the vent piping. Hence, the fuel tank is sealed and evaporated fuel in the fuel tank does not migrate to the canister.

When the state of fuelling of the fuel tank is detected by the fuelling state sensor, the control device controls the solenoid valve and opens up the second bypass channel. Because the back pressure chamber is opened to the atmosphere, it goes to a state in which the pressure in the back pressure chamber is lower than the pressure in the main chamber, and the valve member opens the vent piping. That is, during fuelling of the fuel tank, fuel in the fuel tank may be sent to the canister through the vent piping.

In a sixth aspect of the present invention, in the fifth aspect, a tank internal pressure sensor that detects the tank internal pressure of the fuel tank is provided, wherein the control device controls the solenoid valve so as to open the second bypass channel if the tank internal pressure detected by the tank internal pressure sensor exceeds a predetermined value.

Thus, if the tank internal pressure of the fuel tank goes above the predetermined value, the solenoid valve is controlled and the second bypass channel is opened up. Hence, air in the fuel tank migrates, in order, through the vent piping (a portion thereof at the fuel tank side) and through the first bypass channel, the back pressure chamber, the second bypass channel and the vent piping (a portion thereof at the canister side) to the canister. Therefore, an excessive rise in the tank internal pressure, for example, during running of the vehicle, may be suppressed. The tank internal pressure and amounts of evaporated fuel migrating to the canister may be adjusted by adjustments of a degree of opening of the solenoid valve.

In a seventh aspect of the present invention, in the fifth or sixth aspect, the solenoid valve is set with a valve-opening pressure at which the solenoid valve opens, regardless of control by the control device, if a pressure of the fuel tank exceeds a predetermined positive pressure threshold.

When a pressure exceeding the predetermined positive pressure threshold acts on the solenoid valve from the fuel tank, the solenoid valve opens up regardless of control by the control device. Therefore, even when, for example, the vehicle is parked, the second bypass channel may be opened up and an excessive rise in the tank internal pressure suppressed.

In an eighth aspect of the present invention, in any one of the fifth to seventh aspects, the valve member is set with a valve-opening pressure at which the valve member opens so as to enable fluid communication through the vent piping if a pressure of the fuel tank is below a predetermined negative pressure threshold.

When a pressure falling below the predetermined negative pressure threshold acts on the valve member from the fuel tank, the valve member opens up to enable fluid communication through the vent piping. Therefore, even when, for example, the vehicle is parked, the second bypass channel may be opened up and an excessive fall in the tank internal pressure suppressed.

### Advantageous Effects of Invention

With the configurations described above, the present invention may reduce the size of a solenoid valve on piping that communicates between a fuel tank and a canister.

### BRIEF DESCRIPTION OF DRAWINGS

FIG. 1 is a schematic diagram showing overall structure of a fuel tank system in accordance with a first exemplary embodiment of the present invention.

FIG. 2 is a sectional diagram showing a partial magnification of the fuel tank system in accordance with the first exemplary embodiment of the present invention, in a state in which a diaphragm valve and a solenoid valve are closed.

FIG. 3 is a sectional diagram showing a partial magnification of the fuel tank system in accordance with the first exemplary embodiment of the present invention, in a state in which the diaphragm valve is closed and the solenoid valve is opened.

FIG. 4 is a sectional diagram showing the fuel tank system in accordance with the first exemplary embodiment of the present invention, in a state in which the diaphragm valve and the solenoid valve are opened.

FIG. 5 is a sectional diagram showing a partial magnification of the fuel tank system in accordance with the first exemplary embodiment of the present invention, in a state in which the diaphragm valve is opened and the solenoid valve is closed.

FIG. 6 is a sectional diagram showing a partial magnification of a fuel tank system of a variant example of the first exemplary embodiment of the present invention, in a state in which a diaphragm valve and a solenoid valve are closed.

### BEST MODE FOR CARRYING OUT THE INVENTION

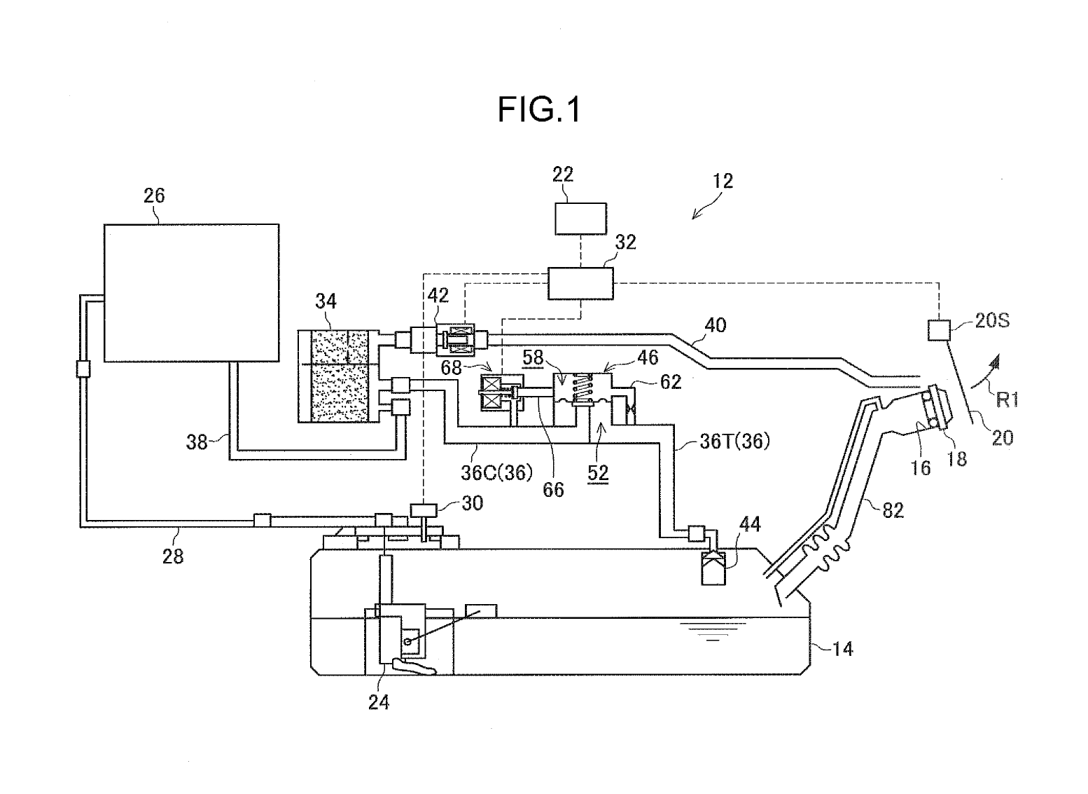

FIG. 1 illustrates a fuel tank system 12 according to a first exemplary embodiment of the present invention. The fuel tank system 12 includes a fuel tank 14 that is capable of accommodating fuel thereinside.

A lower portion of a fuelling pipe 82 is connected to the fuel tank 14. An upper end of the fuelling pipe 82 is formed as a filler opening 16. A fuel nozzle may be inserted into the filler opening 16 and the fuel tank 14 may be fuelled. Except during fuelling, the filler opening 16 is closed off by, for example, a filler opening cap 18 or the like.

A lid 20 is provided at a body panel of an automobile. The lid 20 covers the filler opening 16 and the filler opening cap 18 from the vehicle body outer side. The lid 20 is turned in the direction of arrow R1 by a control device 32 when a lid opener switch 22 is operated. In the state in which the lid 20 has been turned in the direction of arrow R1 thus, the filler opening cap 18 may be removed from the filler opening 16 and a fuel nozzle may be inserted into the filler opening 16.

Open and closed states of the lid 20 are detected by a lid opening/closing sensor 20S and transmitted to the control device 32. In the present exemplary embodiment, the state in which the lid 20 is open is regarded as a “fuel tank fuelling state”. The lid opening/closing sensor 20S serves as an example of a fuelling state sensor. Instead of the lid opening/closing sensor 20S, a sensor that detects a state of attachment/detachment of the filler opening cap 18 or the like may be used as the fuelling state sensor.

A fuel pump 24 is provided inside the fuel tank 14. The fuel pump 24 and an engine 26 are connected by fuel supply piping 28. The fuel in the fuel tank 14 may be sent through the fuel supply piping 28 to the engine 26 by driving of the fuel pump 24.

A tank internal pressure sensor 30 is provided at the fuel tank 14. The tank internal pressure sensor 30 detects a tank internal pressure in the fuel tank 14, and sends this information to the control device 32.

A canister 34 is provided in the fuel tank system 12. An adsorbent that is capable of adsorbing evaporated fuel (activated carbon or the like) is accommodated inside the canister 34. The canister 34 and an upper portion of the fuel tank 14 are connected by vent piping 36. Evaporated fuel produced inside the fuel tank 14 is sent to the canister 34 via the vent piping 36.

Purge piping 38 and an atmospheric opening pipe 40 are connected to the canister 34. The purge piping 38 is in fluid communication with the engine 26. The atmospheric opening pipe 40 opens the interior of the canister 34 to the atmosphere. During driving of the engine 26 and the like, negative pressure acts from the engine 26, and the evaporated fuel that has been adsorbed by the adsorbent in the canister 34 may be desorbed and sent to the engine 26. At the same time, atmospheric air is introduced to the canister 34 through the atmospheric opening pipe 40.

A diagnostic pump 42 is provided at the atmospheric opening pipe 40. The diagnostic pump 42 is controlled by the control device 32. The diagnostic pump 42 causes a predetermined pressure to act in the fuel tank system 12 via the canister 34, and is used when a malfunction of the fuel tank system 12 or the like is to be diagnosed.

A full tank regulation valve 44 is mounted at one end of the vent piping 36 (an end portion inside the fuel tank 14). The full tank regulation valve 44 is open when a surface of liquid fuel in the fuel tank 14 is below a predetermined tank-full liquid level. Thus, evaporated fuel in the fuel tank 14 may be sent to the canister 34. When the surface of the liquid fuel in the fuel tank 14 goes above the predetermined liquid level (the full-tank liquid level), the full tank regulation valve 44 is closed. Hence, evaporated fuel in the fuel tank 14 does not flow to the canister 34. If further fuel is supplied into the fuel tank 14 in this state, the fuel rises up the fuelling pipe 82 and reaches the fuel nozzle, an auto-stop function of the fuel nozzle operates, and the fuelling is stopped.

A diaphragm valve 46 is provided at a middle portion of the vent piping 36 (a portion between the fuel tank 14 and the canister 34). The diaphragm valve 46 is an example of a valve member of the present invention. Herebelow, where required, the vent piping 36 at the fuel tank side relative to this diaphragm valve 46 is referred to as tank side vent piping 36T, and the vent piping 36 at the canister 34 side relative to the diaphragm valve 46 is referred to as canister side vent piping 36C.

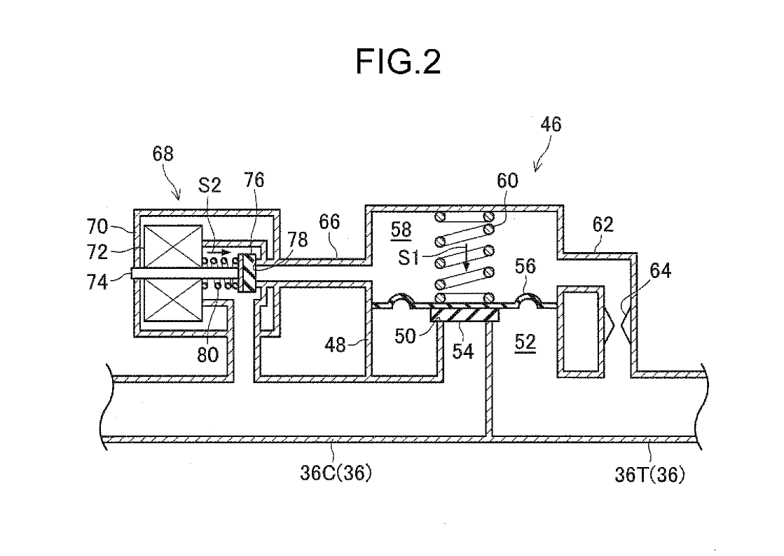

As illustrated in detail in FIG. 2, the diaphragm valve 46 includes a valve housing 48 at an other end side of the tank side vent piping 36T, in the shape of a compressed circular tube with a broad diameter. Inside the valve housing 48, one end side of the canister side vent piping 36C is accommodated so as to be coaxial with the valve housing 48, and a valve seat 50 is structured. A region between the valve seat 50 and the valve housing 48 serves as a main chamber 52. As can be seen in FIG. 1, the main chamber 52 is capable of fluid communication with the interior of the fuel tank 14 via the tank side vent piping 36T.

An opening portion at the upper end of the valve seat 50 may be closed by a valve member main body 54. The periphery of the valve member main body 54 is anchored to an inner periphery face of the valve housing 48 by a diaphragm 56. A space at the upper side of FIG. 2 relative to the valve member main body 54 and the diaphragm 56 serves as a back pressure chamber 58. Thus, the main chamber 52 and the back pressure chamber 58 are partitioned by the diaphragm 56.

Of surface areas of the valve member main body 54 and diaphragm 56 that are subject to pressure (pressured areas), a pressured area at the back pressure chamber 58 side is larger than a pressured area at the main chamber 52 side, by an amount corresponding to a cross-sectional area of the valve seat 50.

A compression coil spring 60 is accommodated in the back pressure chamber 58. The compression coil spring 60 applies a predetermined spring force to the valve member main body 54 in a direction toward the valve seat 50 (the direction of arrow S1). In addition, the diaphragm 56 also applies a predetermined spring force to the valve member main body 54 in the direction of arrow S1. Thus, the valve member main body 54 is urged in a direction to close off the opening portion of the valve seat 50. If, for example, internal pressure in the main chamber 52 and internal pressure in the back pressure chamber 58 are approximately equal, the valve member main body 54 fits tightly to the opening portion of the valve seat 50. Thus, the diaphragm valve 46 is in a valve-closed state and movements of air in the vent piping 36 are blocked.

However, if, for example, the back pressure chamber 58 is at a negative pressure of at least a predetermined level relative to the main chamber 52 (a state in which the internal pressure of the back pressure chamber 58 is low), the valve member main body 54 moves to the back pressure chamber 58 side thereof in opposition to the spring forces of the compression coil spring 60 and the diaphragm 56, and the opening portion of the valve seat 50 is opened up. Hence, the diaphragm valve 46 is in a valve-open state, and movements of air in the vent piping 36 are possible.

A first bypass channel 62 is provided between the tank side vent piping 36T and the back pressure chamber 58. Air may move between the fuel tank 14 and the back pressure chamber 58 through the first bypass channel 62.

A reduced diameter portion 64, at which the internal diameter is locally made smaller, is provided in the first bypass channel 62. A predetermined resistance to movements of air between the fuel tank 14 and the back pressure chamber 58 is produced by the reduced diameter portion 64. The reduced diameter portion 64 is an example of a pressure difference preserver of the present invention.

A means for producing a predetermined resistance to movements of air between the fuel tank 14 and the back pressure chamber 58 is not limited to this structure in which the diameter of the first bypass channel 62 is locally reduced. For example, the internal diameter of the whole of the first bypass channel 62 may be made smaller to produce a predetermined resistance to movements of air. Further, the first bypass channel 62 may be inflected at predetermined positions (both sharp bends and smooth curves are possible) to produce a predetermined resistance to movements of air.

A second bypass channel 66 is provided between the canister side vent piping 36C and the back pressure chamber 58. A solenoid valve 68 is provided at a middle portion of the second bypass channel 66.

The solenoid valve 68 includes a solenoid valve housing 70. A coil portion 72, a plunger portion 74 and a solenoid valve main body 76 are included inside the solenoid valve housing 70. The coil portion 72 is electrified and controlled by the control device 32. The plunger portion 74 receives driving force from the coil portion 72 and moves in the direction of arrow S2 and in the opposite direction. The solenoid valve main body 76 is provided in a circular disc shape at a distal end of the plunger portion 74. A portion of the second bypass channel 66 (the middle portion) passes through the interior of the solenoid valve housing 70.

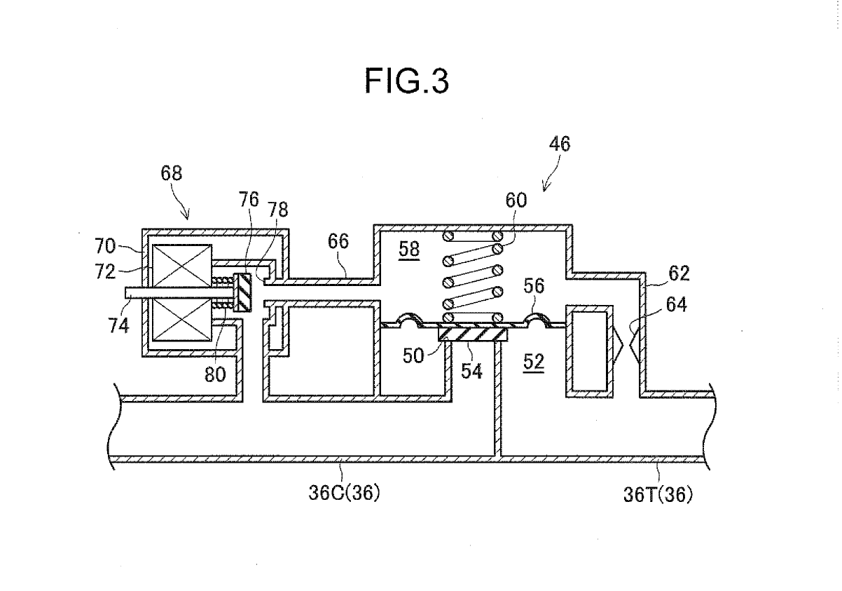

In a state in which the solenoid valve main body 76 is touching a valve seat 78 provided at the second bypass channel 66, the solenoid valve main body 76 closes the second bypass channel 66. In contrast, as shown in FIG. 3, when the solenoid valve main body 76 is moved away from the valve seat 78, air may move through the second bypass channel 66. In the present exemplary embodiment, the orientation of the solenoid valve main body 76 is specified such that the direction in which the solenoid valve main body 76 moves away from the valve seat 78, which is to say the direction of movement of the solenoid valve main body 76 when opening the second bypass channel 66, matches a direction in which a positive pressure from the back pressure chamber 58 is received.

A compression coil spring 80 is mounted at the plunger portion 74. The compression coil spring 80 applies a predetermined spring force to the solenoid valve main body 76 in the direction of arrow S2, such that the solenoid valve main body 76 is not unintendedly moved away from the valve seat 78. The spring force of the compression coil spring 80 is set to a predetermined value such that the solenoid valve main body 76 moves in the direction opposite to arrow S1, regardless of electrification of the coil portion 72, if a positive pressure of a predetermined value or greater acts from the back pressure chamber 58.

Next, operation of the fuel tank system 12 of the present exemplary embodiment is described.

In the fuel tank system 12 of the present exemplary embodiment, the solenoid valve main body 76 of the solenoid valve 68 is closed as shown in FIG. 2 in usual states, that is, states in which the fuel tank 14 is not being fuelled (in which the vehicle may be running and may be parked). The valve member main body 54 of the diaphragm valve 46 is also closed. That is, the fuel tank 14 is in a sealed state such that evaporated fuel from inside the fuel tank 14 does not migrate to the canister 34. Therefore, the tank internal pressure of the fuel tank 14 acts at both of the main chamber 52 and the back pressure chamber 58 of the diaphragm valve 46. The valve-closed state of the diaphragm valve 46 is maintained by the spring forces of the compression coil spring 60 and the diaphragm 56, and unintended valve-opening does not occur.

When fuel is to be fuelled, the lid opener switch 22 is operated, the control device opens up the lid 20 and, as shown in FIG. 3, the control device 32 opens up the solenoid valve 68. Thus, the back pressure chamber 58 of the diaphragm valve 46 is opened up to the atmosphere through the atmospheric opening pipe 40, via the canister 34, the canister side vent piping 36C and the second bypass channel 66. Thus, the pressure in the back pressure chamber 58 falls and approaches atmospheric pressure.

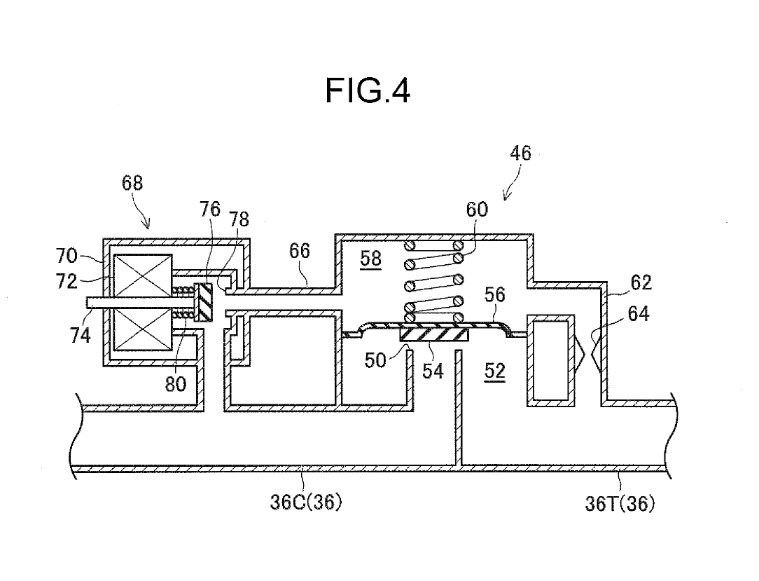

Meanwhile, the main chamber 52 is also opened up to the atmosphere through the back pressure chamber 58, via the first bypass channel 62 and the tank side vent piping 36T. However, the main chamber 52 takes a longer time than the back pressure chamber 58 to get to a pressure at about the same level as the back pressure chamber 58. In other words, there is a state in which there is a pressure difference between the back pressure chamber 58 and the main chamber 52 (a state in which the back pressure chamber 58 has a lower pressure than the main chamber 52). Therefore, the diaphragm valve 46 may be opened with a smaller valve-opening pressure than in a configuration in which this pressure difference between the back pressure chamber 58 and the main chamber 52 does not occur. Thus, as shown in FIG. 4, the valve member main body 54 moves to the back pressure chamber 58 side (the upper side), and the diaphragm valve 46 is opened.

Here in order to open the diaphragm valve 46 with a small valve-opening pressure, a reduction in size of the valve member main body 54 may be considered. However, because the valve member main body 54 is the member that closes off the valve seat 50, if the valve member main body 54 is reduced in size, the valve seat 50, which is to say the inner diameter of a portion of the canister side vent piping 36C, also needs to be reduced in size. Therefore, with a view to assuring flow volumes in the vent piping 36 when the diaphragm valve 46 is open, it is desirable for the valve seat 50 to have a larger diameter. Accordingly, although the valve member main body 54 is increased in diameter, this valve member main body 54 with an increased diameter may be opened by a small valve-opening pressure.

In the present exemplary embodiment, the valve member main body 54 of the diaphragm valve 46 may be increased in diameter as described above. Meanwhile, there is no need for the solenoid valve main body 76 of the solenoid valve 68 to realize operations of opening and closing the vent piping 36 (the valve seat 50); it is sufficient that the solenoid valve main body 76 may open and close the second bypass channel 66. Therefore, the solenoid valve main body 76 may be made smaller. At the solenoid valve main body 76, because a surface area that is subject to the tank internal pressure of the fuel tank 14 is smaller, a pushing load required to close the solenoid valve 68 (a load in the direction of arrow S2 in FIG. 2) may be smaller. Therefore, a reduction in size and a reduction in power consumption of the solenoid valve 68 may be achieved, and the fuel tank system 12 may be provided with low costs and excellent fuel economy.

In particular, in the present exemplary embodiment, the valve-opening direction of the solenoid valve main body 76 of the solenoid valve 68 matches the direction in which the positive pressure from the back pressure chamber 58 acts on the solenoid valve main body 76 (the direction opposite to arrow S2 in FIG. 2). Therefore, a driving force from the coil portion 72 for causing the solenoid valve main body 76 to move in the valve-opening direction may be small, and a saving of electric power may be measured.

In the present exemplary embodiment, as described above, even if the internal diameter of the valve seat 50 is increased, the valve-opening pressure of the diaphragm valve 46, which is to say a force required for operation of the valve member main body 54, may be small. Because the internal diameter of the valve seat 50, that is, of the vent piping 36, is increased, airflow resistance in the vent piping 36 may be reduced. Therefore, evaporated fuel produced in the fuel tank 14 during fuelling easily flows through the vent piping 36 to the canister 34, and the fuel tank system 12 is easy to fuel.

Further, before fuelling, the diaphragm valve 46 is opened and the tank internal pressure of the fuel tank 14 is lowered. In the present exemplary embodiment, because airflow resistance in the vent piping 36 is smaller, a duration required for the tank internal pressure to fall is shortened, and fuelling in a shorter time is possible.

During running of the vehicle, as shown in FIG. 1, the tank internal pressure of the fuel tank 14 is detected by the tank internal pressure sensor 30. If the tank internal pressure exceeds a predetermined value specified beforehand, the control device 32 closes the solenoid valve 68, as shown in FIG. 2. Because the diaphragm valve 46 is also closed, the fuel tank 14 is sealed, and evaporated fuel produced in the fuel tank 14 does not migrate to the canister 34.

When the tank internal pressure exceeds the predetermined value, the control device 32 controls opening and closing of the solenoid valve 68. When the solenoid valve 68 is open (a state the same as the state shown in FIG. 3), evaporated fuel may migrate from the tank side vent piping 36T, through the first bypass channel 62, the back pressure chamber 58, the second bypass channel 66 and the canister side vent piping 36C, to the canister 34.

By control to open and close the solenoid valve 68 as appropriate, flow volumes of evaporated fuel flowing through the vent piping 36 and the tank internal pressure may be controlled. This control to open and close the solenoid valve 68 may be implemented by adjusting amounts of movement of the solenoid valve main body 76 in the direction of arrow S2 and the opposite direction, and thus adjusting a cross-sectional area of the flow path. This control may also be implemented by duty control (control of times of switching between the valve-open position and the valve-closed position of the valve member main body 54).

Evaporated fuel that is discharged from the fuel tank 14 through the vent piping 36 in this manner may be adsorbed by the adsorbent in the canister 34, and when the engine 26 is driving, may be sent through the purge piping 38 to the engine 26 and combusted in the engine 26.

Moreover, in the fuel tank system 12 of the present exemplary embodiment, this member that adjusts flow volumes in the vent piping 36 when the tank internal pressure exceeds the predetermined value may be combined with the solenoid valve 68 that is for opening the back pressure chamber 58 to the atmosphere during fuelling. Therefore, the structure may be formed at lower cost than a structure in which the members that implement these operations are provided separately, and the weight is lower.

When the vehicle is parked, usually, the solenoid valve 68 and the diaphragm valve 46 are closed. Thus, the fuel tank 14 is sealed, and evaporated fuel produced in the fuel tank 14 does not migrate to the canister 34.

If the tank internal pressure of the fuel tank 14 becomes a positive pressure when the vehicle is parked (a state in which the tank internal pressure is higher than atmospheric pressure), the tank internal pressure acts in the direction of opening the solenoid valve main body 76 of the solenoid valve 68 (the direction opposite to arrow S2 shown in FIG. 2) via the back pressure chamber 58. While the vehicle is parked, the solenoid valve 68 is not controlled to open and close by the control device 32. However, if the tank internal pressure exceeds a predetermined threshold value (hereinafter referred to as a positive pressure threshold), the solenoid valve main body 76 that is subject to the tank internal pressure (positive pressure) moves in the valve-opening direction in opposition to the spring force of the compression coil spring 80, and arrives at the same state as the state shown in FIG. 3. That is, the solenoid valve 68 operates as a positive pressure release valve that releases the positive pressure in the fuel tank 14. Thus, there is no need to provide an additional positive pressure release valve. Therefore, the structure may be formed at a lower cost than a structure in which a positive pressure release valve is separately provided, and the weight is lower.

Moreover, the solenoid valve 68 of the fuel tank system 12 of the present exemplary embodiment is controlled to open and close under predetermined conditions during fuelling and during running and the like, as described above. That is, the solenoid valve main body 76 moves between the valve-open position and the valve-closed position in situations other than situations in which the tank internal pressure exceeds the positive pressure threshold. Therefore, a phenomenon of the solenoid valve main body 76 undesirably adhering to the valve seat 78 is less likely to occur than with a positive pressure release valve that is opened only when the tank internal pressure exceeds the positive pressure threshold. Thus, jamming resistance is improved.

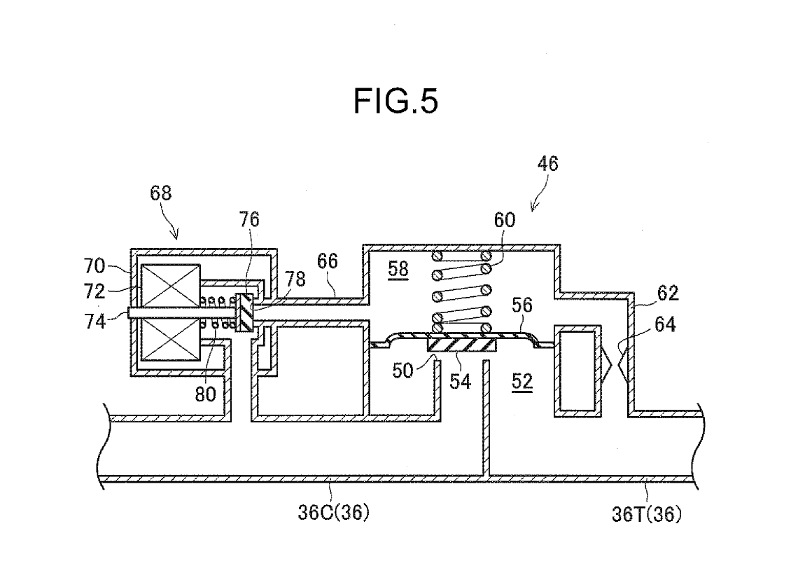

When the vehicle is parked, if the tank internal pressure of the fuel tank 14 goes to a negative pressure (a state in which the tank internal pressure is lower than atmospheric pressure), the tank internal pressure (negative pressure) acts in the direction of opening the valve member main body 54 of the diaphragm valve 46 (the direction opposite to arrow S1 shown in FIG. 2), via the back pressure chamber 58. When the tank internal pressure is lower than a predetermined threshold value (hereinafter referred to as a negative pressure threshold), as shown in FIG. 5, the valve member main body 54 subjected to the tank internal pressure (negative pressure) from the back pressure chamber 58 side moves in the valve-opening direction in opposition to the spring forces of the compression coil spring 60 and the diaphragm 56. That is, the diaphragm valve 46 operates as a negative pressure release valve that releases negative pressure in the fuel tank 14. Thus, there is no need to provide an additional negative pressure release valve. Therefore, the structure may be formed at a lower cost than a structure in which a negative pressure release valve is separately provided, and the weight is lower.

Moreover, the diaphragm valve 46 of the fuel tank system 12 of the present exemplary embodiment is controlled to open and close under predetermined conditions during fuelling and the like, as described above. That is, the valve member main body 54 moves between the valve-open position and the valve-closed position in situations other than situations in which the tank internal pressure falls below the negative pressure threshold. Therefore, a phenomenon of the valve member main body 54 undesirably adhering to the valve seat 50 is less likely to occur than with a negative pressure release valve that is opened only when the tank internal pressure falls below the negative pressure threshold. Thus, jamming resistance is improved.

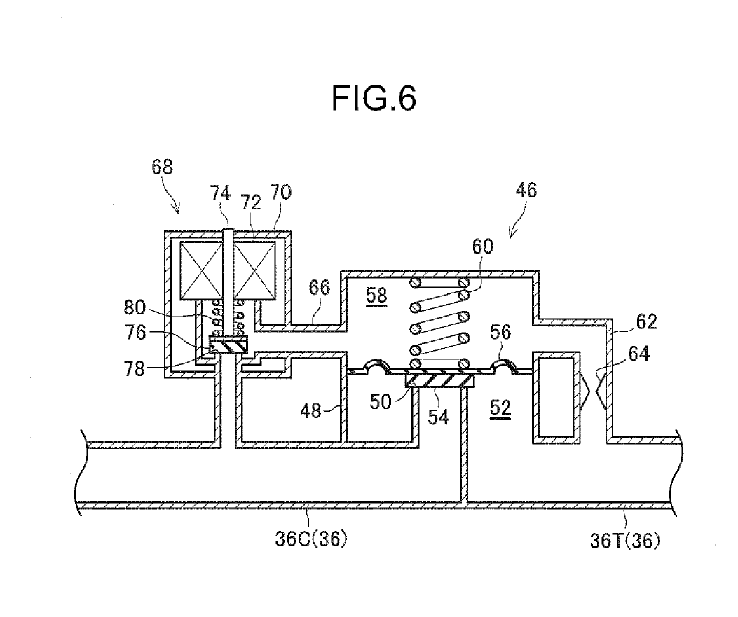

In the above descriptions, an example is given in which the solenoid valve main body 76 of the solenoid valve 68 is oriented with the valve-opening direction thereof matching the direction in which positive pressure from the back pressure chamber 58 acts. However, the valve-opening direction of the solenoid valve main body 76 is not limited thus. As illustrated in FIG. 6, the valve-opening direction of the solenoid valve main body 76 may be opposite to the direction of action of positive pressure from the back pressure chamber 58. In this constitution, driving force from the coil portion 72 for maintaining the solenoid valve main body 76 at the valve-closed position may be reduced.

In the above descriptions, an example is given in which a pressure difference preserver is provided in the first bypass channel 62. However, even if the flow path resistance of the first bypass channel 62 is not increased, a pressure difference may be produced between the back pressure chamber 58 and the main chamber 52 when the solenoid valve 68 closes and the back pressure chamber 58 approaches atmospheric pressure. When the pressure difference preserver is provided at the first bypass channel 62, the state in which there is a pressure difference between the back pressure chamber 58 and the main chamber 52 (the state in which the pressure in the back pressure chamber 58 is lower than the pressure in the main chamber 52) may be more assuredly maintained.

In particular, when the reduced diameter portion 64 described above is used as a flow path resistance adjuster, the pressure difference preserver may be constituted with a simple structure. By the internal diameter and length or the like of the reduced diameter portion 64 being specified as appropriate, the flow path resistance may be easily adjusted.

An example in which the diaphragm valve 46 serves as the valve member of the present invention is described above, but the valve member is not limited to the diaphragm valve 46. For example, a structure is possible in which the diaphragm 56 is eliminated and the valve member main body 54 is increased in diameter such that the outer periphery of the valve member main body 54 is in contact with the inner periphery of the valve housing 48. In this structure, the valve member main body 54 alone partitions the main chamber 52 from the back pressure chamber 58, and the valve member main body 54 moves between a position at which it closes the vent piping 36, by touching the valve seat 50, and a position at which it opens the vent piping 36, by moving away from the valve seat 50.

1. A fuel tank system comprising:
a fuel tank capable of accommodating fuel therein;
a canister that adsorbs and desorbs evaporated fuel, produced in the fuel tank, with an adsorbent;
an atmospheric opening pipe for opening an interior of the canister to the atmosphere;
vent piping that provides fluid communication between the fuel tank and the canister such that evaporated fuel in the fuel tank can flow to the canister;
a valve member that partitions a main chamber from a back pressure chamber that is provided at an opposite side of a main body of the valve member from the main chamber, the main chamber and the back pressure chamber sandwiching the valve member main body, the main chamber being provided at the vent piping such that a tank internal pressure of the fuel tank acts at the main chamber, and the valve member opening and enabling fluid communication through the vent piping when a pressure in the main chamber is higher than a pressure in the back pressure chamber and the valve member main body moves;
a first bypass channel that provides fluid communication between the vent piping from the fuel tank to the main chamber and the back pressure chamber;
a second bypass channel that provides fluid communication between the vent piping from the main chamber to the canister and the back pressure chamber; and
a solenoid valve that is provided at the second bypass channel and is controlled so as to open and close the second bypass channel.

2. The fuel tank system according to claim 1, further comprising a pressure difference preserver for preserving a pressure difference between the main chamber and the back pressure chamber.

3. The fuel tank system according to claim 2, wherein the pressure difference preserver is a reduced diameter portion at which a cross-sectional area of a flow path in the first bypass channel is locally reduced.

4. The fuel tank system according to claim 1, wherein the solenoid valve comprises a solenoid valve main body, a direction of force of positive pressure from the back pressure chamber matching a direction of movement of the solenoid valve main body when opening the second bypass channel.

5. The fuel tank system according to claim 1, further comprising:
a fueling state sensor that detects a fueling state of the fuel tank; and
a control device that controls the solenoid valve so as to close the second bypass channel in a state in which the fueling state of the fuel tank is not detected by the fueling state sensor, and so as to open the second bypass channel when the fueling state of the fuel tank is detected.

6. The fuel tank system according to claim 5, further comprising a tank internal pressure sensor that detects the tank internal pressure of the fuel tank, wherein the control device controls the solenoid valve so as to open the second bypass channel if the tank internal pressure detected by the tank internal pressure sensor exceeds a predetermined value.

7. The fuel tank system according to claim 5, wherein the solenoid valve is set with a valve-opening pressure at which the solenoid valve opens, regardless of control by the control device, if a pressure of the fuel tank exceeds a predetermined positive pressure threshold.

8. The fuel tank system according to claim 5, wherein the valve member is set with a valve-opening pressure at which the valve member opens so as to enable fluid communication through the vent piping if a pressure of the fuel tank is below a predetermined negative pressure threshold.
